(19) United States
(12) Patent Application Publication
(10) Pub. No.: US 2024/0103498 A1
(43) Pub. Date: Mar. 28, 2024

(54) SYSTEMS AND METHODS OF REMOTELY CONTROLLING CHANNEL RESETS FOR INPUT/OUTPUT MODULES OF INDUSTRIAL SYSTEMS

(71) Applicant: ROCKWELL AUTOMATION TECHNOLOGIES, INC., MAYFIELD HEIGHTS, OH (US)

(72) Inventors: Alex W. Stephens, Painesville, OH (US); Christopher D. Woggon, Mayfield Heights, OH (US); Daniel D. Judkins, Richmond Heights, OH (US)

(21) Appl. No.: 17/955,529

(22) Filed: Sep. 28, 2022

(51) Int. Cl. G05B 19/418

(52) U.S. Cl. CPC G05B 19/4185; G05B 19/4184

(57) ABSTRACT

Systems and methods for providing remote channel reset for input/output modules of industrial systems. One system includes a plurality of channel circuits for interfacing with industrial control equipment of an industrial system. The system also includes an electronic processor communicatively coupled to each channel circuit via a dedicated hardware communication channel. The electronic processor is configured to control a power state for at least one channel circuit included in the plurality of channel circuits.

### CROSS-REFERENCES TO RELATED APPLICATIONS

Not applicable.

### BACKGROUND INFORMATION

Industrial controllers are specialized computer systems used for the control of industrial processes or machinery, for example, in a factory environment. Generally, an industrial controller executes a stored control program that reads inputs from a variety of sensors associated with the controlled process and machine and, sensing the conditions of the process or machine and based on those inputs and a stored control program, calculates a set of outputs used to control actuators controlling the process or machine.

Industrial controllers differ from conventional computers in a number of ways. Physically, they are constructed to be substantially more robust against shock and damage and to better resist external contaminants and extreme environmental conditions than conventional computers. The processors and operating systems are optimized for real-time control and are programmed with languages designed to permit rapid development of control programs tailored to a constantly varying set of machine control or process control applications.

Generally, the controllers have a highly modular architecture, for example, that allows different numbers and types of input and output modules to be used to connect the controller to the process or machinery to be controlled. This modularity is facilitated through the use of special “control networks” suitable for highly reliable and available real-time communication. Such control networks (for example, ControlNet or EtherNet/IP) differ from standard communication networks (such as Ethernet) by guaranteeing maximum communication delays by pre-scheduling the communication capacity of the network, and/or providing redundant communication capabilities for high-availability.

As part of their enhanced modularity, industrial controllers may employ input/output (“I/O”) modules or devices. Each of these I/O modules or devices may have a connector system allowing them to be installed in different combinations in a housing or rack along with other selected I/O modules or devices to match the demands of the particular application or industrial system. Multiple or individual I/O modules or devices may be located at convenient control points near the controlled process or machine to communicate with a central industrial controller via the control network.

### SUMMARY

The following presents a simplified summary of the disclosed technology herein in order to provide a basic understanding of some aspects of the disclosed technology. This summary is not an extensive overview of the disclosed technology. It is intended neither to identify key or critical elements of the disclosed technology nor to delineate the scope of the disclosed technology. Its sole purpose is to present some concepts of the disclosed technology in a simplified form as a prelude to the more detailed description that is presented later.

The technology disclosed herein relates generally to industrial systems, and, more particularly, to providing remote channel resets for I/O modules of industrial systems.

The configurations described herein provide for the ability to power circuitry on and off for a specific I/O channel on demand. The technology disclosed herein may be implemented on a hardware setup where individual channels of an I/O device are electrically isolated (via individual dedicated hardware channels).

Accordingly, the configurations described herein provide for systems and methods for attempting to clear recoverable faults or control the power of a channel in an I/O module or device by enabling a user, embedded software, or the like to select a specific channel on which power can be cycled. As one non-limiting example, the technology disclosed herein may be implemented for clearing faults, such as, e.g., where software detects a fault and automatically power cycles a channel or alerts a user to act, where a user detects and manually triggers a power cycle of a channel, or a combination thereof. As another non-limiting example, the technology disclosed herein may be implemented for disabling/enabling a channel, marking a channel as unused or a specific data type, or the like by, e.g., powering off or on an I/O channel circuitry (e.g., on-demand control).

The technology described herein improves channel power capabilities of past I/O devices and modules. For instance, in some prior I/O modules, only soft resets of a channel's microprocessor were possible. Additionally, previous I/O modules could also cycle power to an entire device, but such cycles have implications on whole module availability. As such, the technology described herein provides a technical improvement by enabling the clearing of both recoverable electrical faults and recoverable software faults by cycling the power on the channel's circuitry. Such technical improvements enable more uptime to the end user in the presence of individual channel faults. Additionally, the technology disclosed herein enable more planning with respect to the distribution of power in I/O racks so that an end user doesn't need special previsions to remotely cycle power to an I/O channel.

Accordingly, configurations described herein provide systems and methods for providing remote channel reset for I/O modules of industrial systems. One configuration provides an I/O module for industrial systems. The I/O module includes a plurality of channel circuits for interfacing with industrial control equipment of an industrial system. The I/O module also includes an electronic processor communicatively coupled to each channel circuit via a dedicated hardware communication channel, the electronic processor configured to control a power state for at least one channel circuit included in the plurality of channel circuits.

Another configuration provides a system for providing remote channel reset for I/O modules of industrial systems. The system includes a plurality of channel circuits for interfacing with industrial control equipment of an industrial system. The system also includes an electronic processor communicatively coupled to each channel circuit via a dedicated hardware communication channel, the electronic processor configured to control a power state for at least one channel circuit included in the plurality of channel circuits.

Yet another configuration provides a method for providing remote channel reset for I/O modules of industrial systems. The method includes providing a multichannel I/O module for implementation with an industrial system, the multichannel I/O module including a first channel circuit electronically and a second channel circuit, wherein the first channel circuit is controlled independently from the second channel circuit. The method also includes controlling, with an electronic processor communicatively coupled to the first channel circuit and the second channel circuit, a first power state associated with the first channel circuit via transmission of a first control signal using a first dedicated hardware communication channel communicatively coupling the electronic processor to the first channel circuit.

The foregoing and other aspects and advantages of the present disclosure will appear from the following description. In the description, reference is made to the accompanying drawings which form a part hereof, and in which there is shown by way of illustrations one or more embodiments of the present disclosure. Such configurations do not necessarily represent the full scope of the present disclosure, however, and reference is made therefore to the claims and herein for interpreting the scope of the present disclosure.

### BRIEF DESCRIPTION OF DRAWINGS

The present disclosure will be better understood and features, aspects and advantages other than those set forth above will become apparent when consideration is given to the following detailed description thereof. Such detailed description makes reference to the following drawings.

FIG. 1 schematically illustrates a system for providing remote channel reset for I/O modules of industrial systems in accordance with some configurations.

FIG. 2 schematically illustrates an example user device of the system of FIG. 1 according to some configurations.

FIG. 3 schematically illustrates an example industrial system of the system of FIG. 1 according to some configurations.

FIG. 4 schematically illustrates an example I/O module according to some configurations.

FIG. 5 schematically illustrates an example I/O controller of the I/O module of FIG. 4 according to some configurations.

FIG. 6 is a flowchart illustrating a method for providing remote channel reset for I/O modules of industrial systems using the system of FIG. 1 in accordance with some configurations.

### DETAILED DESCRIPTION

As utilized herein, terms “component,” “system,” “controller,” “device,” “manager,” and variants thereof are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The disclosed technology is described with reference to the drawings, wherein like reference numerals are used to refer to like elements throughout. In the following description, for purposes of explanation, numerous specific details are set forth in order to provide a thorough understanding of the disclosed technology. It may be evident, however, that the disclosed technology may be practiced without these specific details. In other instances, well-known structures and devices are shown in block diagram form in order to facilitate describing the disclosed technology.

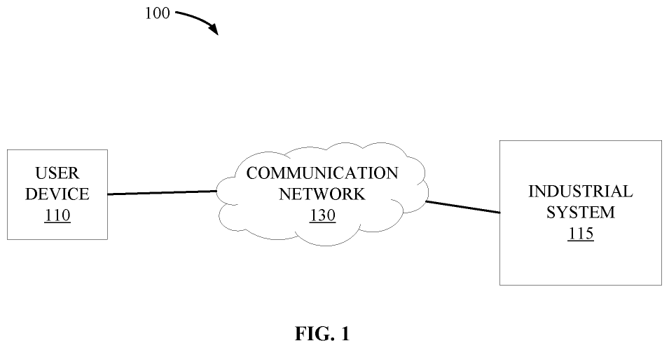

FIG. 1 schematically illustrates a system 100 for providing remote channel resets for I/O modules according to some configurations. In the illustrated example, the system 100 may include a user device 110 and an industrial system 115. In some configurations, the system 100 includes fewer, additional, or different components in different configurations than illustrated in FIG. 1. As one non-limiting example, the system 100 may include multiple user devices 110, multiple industrial systems 115, or a combination thereof. As another non-limiting example, one or more components of the system 100 may be combined into a single device. Alternatively, or in addition, in some configurations, the user device 110 may be included as part of the industrial system 115 (e.g., as a component of the industrial system 115).

The user device 110 and the industrial system 115 may communicate over one or more wired or wireless communication networks 130. Portions of the communication networks 130 may be implemented using a wide area network, such as the Internet, a local area network, such as a BLUETOOTH® or WI-FI®, and combinations or derivatives thereof. Alternatively, or in addition, in some configurations, components of the system 100 may communicate directly as compared to through the communication network 130. Also, in some configurations, the components of the system 100 may communicate through one or more intermediary devices not illustrated in FIG. 1.

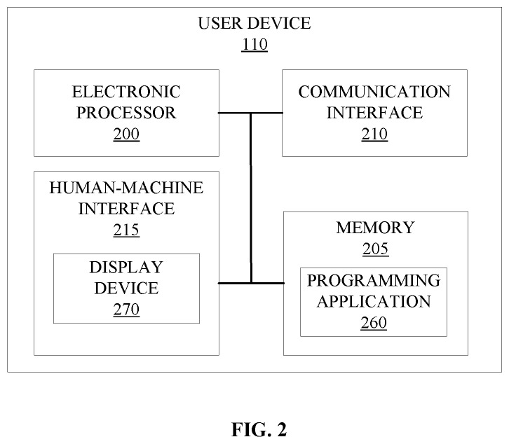

The user device 110 may be a computing device, such as a desktop computer, a laptop computer, a tablet computer, a terminal, a smart telephone, a smart television, a smart wearable, or another suitable computing device that interfaces with a user. As illustrated in FIG. 2, the user device 110 includes an electronic processor 200, a memory 205, a communication interface 210, and a human-machine interface (“HMI”) 215. The electronic processor 200, the memory 205, the communication interface 210, and the HMI 215 communicate wirelessly, over one or more communication lines or buses, or a combination thereof. The user device 110 may include additional components than those illustrated in FIG. 2 in various configurations. The user device 110 may also perform additional functionality other than the functionality described herein. Also, the functionality described herein as being performed by the user device 110 may be distributed among multiple devices (e.g., as part of a cloud service or cloud-computing environment), combined with another component of the system 100 (e.g., combined with the industrial system 115 (or a component thereof)), or a combination thereof.

The communication interface 210 may include a transceiver that communicates with the industrial system 115 over the communication network 130 and, optionally, one or more other communication networks or connections. In some configurations, the communication interface 210 enables the user device 110 to communicate with the industrial system 115 over one or more wired or wireless communication networks or connections. The electronic processor 200 includes a microprocessor, an application-specific integrated circuit (“ASIC”), or another suitable electronic device for processing data, and the memory 205 includes a non-transitory, computer-readable storage medium. The electronic processor 200 is configured to retrieve instructions and data from the memory 205 and execute the instructions.

As one non-limiting example, as illustrated in FIG. 2, the memory 205 includes a programing application 260 (referred to herein as “the application 260”). The application 260 is a software application executable by the electronic processor 200 in the example illustrated and as specifically discussed below, although a similarly purposed module can be implemented in other ways in other examples. The electronic processor 200 executes the application 260 to facilitate user programming for industrial devices or controllers, such as, e.g., a fault detection response protocol, a ladder logic program for fault handling and detection, and the like.

As noted above, in some configurations, the functionality (or a portion thereof) described herein as being performed by the user device 110 may be distributed among multiple devices (e.g., as part of a cloud service or cloud-computing environment). As one non-limiting example, in some configurations, the system 100 may include a server (e.g., a computing device). The server may include similar components as the user device 110, such as an electronic processor (e.g., a microprocessor, an ASIC, or another suitable electronic device), a memory (e.g., a non-transitory, computer-readable storage medium), a communication interface, such as a transceiver, for communicating over the communication network 130 and, optionally, one or more additional communication networks or connections. Accordingly, in some embodiments, the server may store the application 260 as part of providing a programming service through the server. In such configurations, to communicate with the server (e.g., interact with the application 260), the user device 110 may store a browser application or a dedicated software application executable by the electronic processor 200.

As noted above, the user device 110 may also include the HMI 215 for interacting with a user. The HMI 215 may include one or more input devices, one or more output devices, or a combination thereof. Accordingly, in some configurations, the HMI 215 allows a user to interact with (e.g., provide input to and receive output from) the user device 110. For example, the HMI 215 may include a keyboard, a cursor-control device (e.g., a mouse), a touch screen, a scroll ball, a mechanical button, a display device (e.g., a liquid crystal display (“LCD”)), a printer, a speaker, a microphone, or a combination thereof. As illustrated in FIG. 2, in some configurations, the HMI 215 may include a display device 270. The display device 270 may be included in the same housing as the user device 110 or may communicate with the user device 110 over one or more wired or wireless communication networks or connections. For example, in some configurations, the display device 270 is a touchscreen included in a laptop computer or a tablet computer. In other configurations, the display device 270 is a monitor, a television, or a projector coupled to a terminal, desktop computer, or the like via one or more cables.

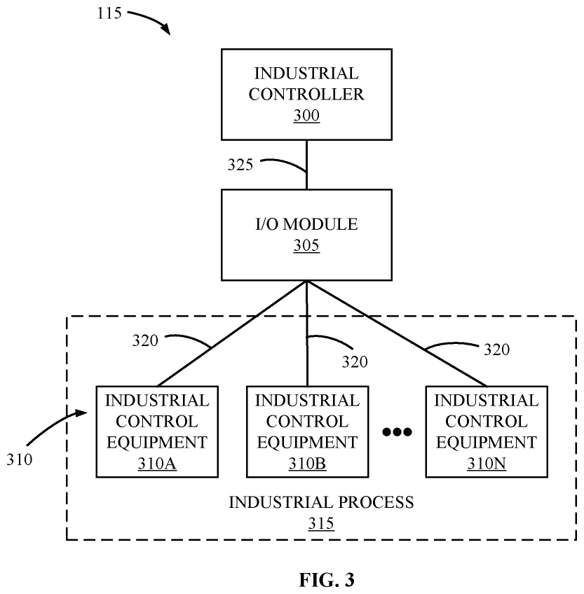

FIG. 3 schematically illustrates an example of the industrial system 115 according to some configurations. In the illustrated example of FIG. 3, the industrial system 115 may include an industrial controller 300, an I/O module 305, and at least one piece of industrial control equipment 310. In some configurations, the industrial system 115 includes fewer, additional, or different components in different configurations than illustrated in FIG. 3. As one non-limiting example, the industrial system 115 may include multiple industrial controllers 300, multiple I/O modules 305, or a combination thereof. As another non-limiting example, one or more components of the industrial system 115 may be combined into a single device. Alternatively, or in addition, in some configurations, the user device 110 may be included as part of the industrial system 115 (e.g., as a component of the industrial system 115).

The industrial system 115 may be a manufacturing system, such as, e.g., an industrial automation system or the like. The industrial system 115 may perform one or more industrial processes, manufacturing processes, production processes, or the like (represented in FIG. 3 as an industrial process 315). In some configurations, the industrial system 115 may perform a production process that produces goods or products. As one non-limiting example, the industrial system 115 may perform a vehicle manufacturing process to assemble or produce a vehicle (or various components thereof). As another non-limiting example, the industrial system 115 may perform a food manufacturing process for making a food product.

The industrial controller 300, which could be a programmable logic controller (“PLC”), may store and execute a control program for the control of the industrial process 315 as is generally understood in the art. The industrial controller 300 may include similar components as the user device 110, such as an electronic processor (e.g., a microprocessor, an ASIC, or another suitable electronic device), a memory (e.g., a non-transitory, computer-readable storage medium), a communication interface, and the like. The industrial process 315, for example, may coordinate a set of machines on an assembly line or the like, or interact with actuators, sensors and/or other industrial control equipment of plant processing materials to control that process, or conduct other similar control applications (via, e.g., the industrial control equipment 310A, 310B, 310N of FIG. 3).

As illustrated in FIG. 3, the industrial controller 300 may communicate with at least one I/O module 305 providing a direct interface to the industrial control equipment 310 of the industrial process 315. In some configurations, the I/O module 305 provides input and output lines via electrical conductors 320 to and from the industrial process 315 allowing communication with the industrial control equipment 310, such as industrial control equipment 310A, 310B, and 310N. The industrial control equipment 310 may include, e.g., a digital actuator (e.g., a relay, an indicator light, a motor, or the like), a digital sensor (e.g., a photoelectric sensor, a dry contact sensor, an inductive sensor, a push button, or the like), an analog actuator (e.g., a valve, a positioner, a meter, or the like), an analog sensor (e.g., a level sensor for a tank, a temperature sensor, a position sensor, or the like), or the like.

The industrial controller 300 can communicate with the I/O module 305 through an industrial control network 325. The industrial control network 325 may include, e.g., Common Industrial Protocol (“CIP”), EtherNet/IP, DeviceNet, CompoNet, ControlNet network, or the like (e.g., a network whose specifications are published and whose protocols are used broadly by a number of manufacturers and suppliers). Such networks may provide for high reliability transmission of data in real time (or near real-time) and can provide features ensuring timely delivery (e.g., by pre-scheduling communication resources, such as network bandwidth, network buffers, and the like).

The industrial controller 300 can also communicate, through a data network (which may, but need not be, an industrial control network), with a central computer system (e.g., via one or more routers or switches). As one non-limiting example, the industrial controller 300 may communicate via the communication network 130 with the user device 110, as illustrated in FIG. 1.

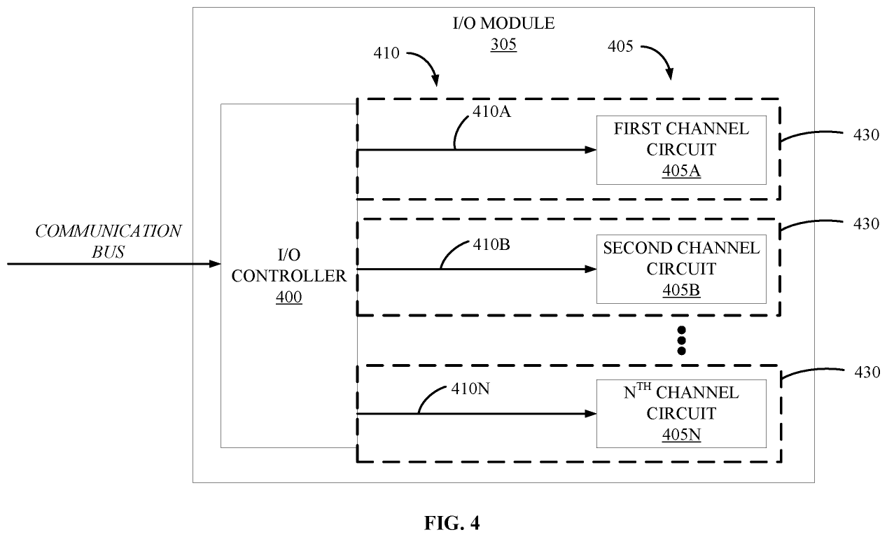

FIG. 4 schematically illustrates an example of the I/O module 305 according to some configurations. In the illustrated example, the I/O module 305 includes an I/O controller 400 and a set of channel circuits 405 (represented in FIG. 4 as a first channel circuit 405A, a second channel circuit 405B, and an N^{th} channel circuit 405N). Accordingly, in some configurations, the I/O module 305 is a multichannel I/O module including a plurality of channel circuits. In some configurations, the I/O module 305 may include fewer, additional, or different components in different configurations than illustrated in FIG. 4.

In the illustrated example, the I/O controller 400 is communicatively coupled to each channel circuit 405 by a hardware communication channel 410 (e.g., a dedicated hardware communication line or channel). For instance, in some configurations, the hardware communication channel 410 is a hardware communication line. In some configurations, the hardware communication line 410 may include a serial communication interface that communicates one bit of information at a time. In some configurations, the hardware communication line 410 may communicate (or transmit) a power control signal, a set of synchronization signals (e.g., a primary synchronization signal and a secondary synchronization signal), or a combination thereof. As one non-limiting example, the I/O controller 400 may use the hardware communication channel 410 to transmit or otherwise communicate a signal, such as a power control signal and a pair of synchronization signals, to the channel circuit 405. As illustrated in FIG. 4, the I/O controller 400 is coupled to the first channel circuit 405A by a first hardware communication channel 410A, the second channel circuit 405B by a second hardware communication channel 410B, and the N^{th} channel circuit 405N by an N^{th} hardware communication channel 410N.

Accordingly, in some configurations, each channel circuit 405 is electrically isolated from each other (via, e.g., the dedicated hardware communication channels 410 as opposed to, e.g., a shared communication channel). For instance, in some configurations, each channel circuit 405 is electrically isolated from each other via an isolation boundary or barrier (represented in FIG. 4 as a dashed box 430). In some configurations, the isolation boundary 430 for a channel circuit 405 also includes at least a portion of the corresponding hardware communication channel 410, as illustrated in FIG. 4. As one non-limiting example, the first channel circuit 405A is electrically isolated from the second channel circuit 405B and the N^{th} channel circuit 405N, the second channel circuit 405B is electrically isolated from the first channel circuit 405A and the N^{th} channel circuit 405N, and the N^{th} channel circuit 405N is electrically isolated from the first channel circuit 405A and the second channel circuit 405B. Accordingly, in some configurations, the I/O module 305 is implemented via a hardware design or setup where individual channels of the I/O module 305 are electrically isolated, such that, e.g., in some configurations, at least one of the channel circuits 405 cannot cause interference with other circuits (e.g., another channel circuit 405) outside of the isolation boundary 430, unless through dedicated interfaces for communicating across the isolation boundary 430 (e.g., a dedicated hardware communication channel 410). Alternatively, or in addition, in some configurations the I/O module 305 is implemented via a hardware design or setup where individual channels of the I/O module 305 are electrically isolated such that, e.g., in some configurations, each of the channel circuits 405 are independently controlled. As one non-limiting example, in such configurations, independent control may be provided via sequencing specific voltage rails up or down independently. In such configurations, the channel circuits 405 may share some common components (e.g., ground). Accordingly, in some configurations, the I/O module 305 may implement multiple power domains. The electrical isolation as described herein provides independence of power control.

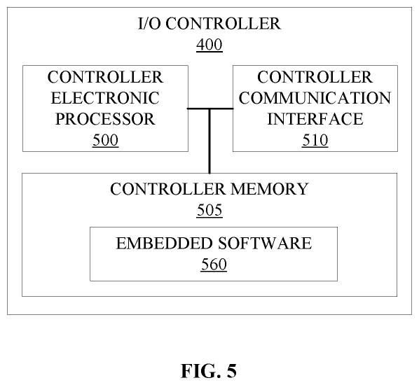

The I/O controller 400 may control a power state of each channel circuit 405 included in the I/O module 305. A power state may include a power-off state (e.g., a disabled state where no power is provided or received), a power-on state (e.g., an enabled state where power is provided or received), or the like. Accordingly, a power state of a channel circuit 405 may represent whether the channel circuit 405 receives power (or is active). In some configurations, as illustrated in FIG. 5, the I/O controller 400 may include a controller electronic processor 500 (e.g., a microprocessor, an ASIC, or another suitable electronic device), a controller memory 505 (e.g., a non-transitory, computer-readable storage medium), and a controller communication interface 510, as similarly described above with respect to the user device 110 of FIG. 2. As illustrated in FIG. 5, the controller memory 505 may include embedded software 560 (e.g., a control program). The embedded software 560 is software executable by the controller electronic processor 500. The controller electronic processor 500 may execute the embedded software 560 to control a power state of one or more channel circuits 405 of the I/O module 305. As one non-limiting example, the controller electronic processor 500 may execute the embedded software 560 to facilitate a remote channel reset for at least one of the channel circuits 405 of the I/O module 305.

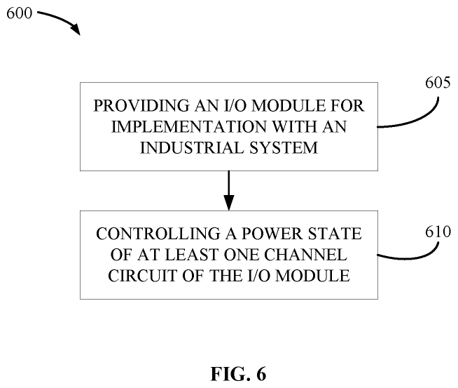

FIG. 6 is a flowchart illustrating a method 600 of providing remote channel resets for I/O modules (e.g., the I/O module 305) according to some configurations. As illustrated in FIG. 6, the method 600 includes providing an I/O module (e.g., the I/O module 305) for implementation with an industrial system (e.g., the industrial system 115) (at block 605). The method 600 then includes controlling a power state of at least one channel circuit 405 of the I/O module 305 (at block 610).

As noted herein, in some configurations, the controller electronic processor 500 may control a power state of a channel circuit 405 of the I/O module 305. The controller electronic processor 500 may control a power state of a channel circuit 405 by generating and transmitting one or more control signals. The controller electronic processor 500 may transmit a control signal for a channel circuit 405 via a corresponding dedicated hardware communication channel (e.g., the first hardware communication channel 410A, the second hardware communication channel 410B, the N^{th} hardware communication channel 410N, or the like as illustrated in FIG. 4). As one non-limiting example, the controller electronic processor 500 may transmit a first control signal to the first channel circuit 405A using the first hardware communication channel 410A, which communicatively couples the I/O controller 400 (e.g., the controller electronic processor 500) to the first channel circuit 405A. As another non-limiting example, the controller electronic processor 500 may transmit a second control signal to the second channel circuit 405B using the second hardware communication channel 410B, which communicatively couples the I/O controller 400 (e.g., the controller electronic processor 500) to the second channel circuit 405A.

The control signal may trigger a change in power state with respect to the receiving channel circuit. As one non-limiting example, the control signal may change a power state of a receiving channel circuit from a power-on state to a power-off state (e.g., disabling power or turning power off). As another non-limiting example, the control signal may change a power state of the receiving channel circuit from a power-off state to a power-on state (e.g., enabling power or turning power on).

Accordingly, in some configurations, the controller electronic processor 500 may control the power state of a channel circuit 405 by disabling power to the channel circuit 405. As one non-limiting example, when a channel circuit 405 is not utilized by a configuration of the industrial system 115 (e.g., is unused), the controller electronic processor 500 may control a power state of the channel circuit 405 by disabling power to the channel circuit 405. Alternatively, or in addition, in some configurations, the controller electronic processor 500 may control the power state of the channel circuit 405 by performing a power reset cycle for the channel circuit 405, such as, e.g., to clear a fault associated with the channel circuit 405. The fault associated with the at least one channel circuit may be a hardware fault, a software fault, or a combination thereof.

In some configurations, the controller electronic processor 500 may control the power state for the channel circuit 405 in response to detecting a fault associated with the channel circuit 405, detecting that the channel circuit 405 is unused by the industrial system 115, or the like. Alternatively, or in addition, in some configurations, the controller electronic processor 500 may control the power state for the channel circuit 405 in response to receiving a request. In some configurations, the request may be a remote request initiated by a remote device (e.g., a device remote from the I/O module 305). As one non-limiting example, the request may be initiated by a user of the user device 110. For instance, a user may be notified of a fault associated with a channel circuit 405 and initiate a power reset cycle for that channel circuit 405 (on-demand) via the user device 110. Accordingly, in some configurations, a request may be manually generated or initiated by a user via the user device 110. Alternatively, or in addition, the request may be automatically generated or initiated. As one non-limiting example, in some configurations, an external logic program (e.g., a ladder logic program) may automatically generate or initiate a request, such as, e.g., in response to detecting a fault associated with the channel circuit 405 or the like.

Accordingly, the configurations described herein provide for remote channel reset for I/O modules of industrial systems. For instance, as described in greater detail herein, one or more channel circuits 405 of the I/O module 305 may be reset by, e.g., an established connection (e.g., or a control signal). The reset performs a power cycle of the channel's circuitry (e.g., microprocessor and associated isolated hardware) (e.g., the channel circuit 405A, 405B, 405N). Embedded software (e.g., the embedded software 560) can also use this capability to clear hardware faults, leave a channel circuit fully disconnected when desired, or the like. Accordingly, in some configurations, embedded software (as executed by the I/O controller 400) may power cycle the field side hardware when a fault is encountered. Accordingly, the configurations described herein enable clearing of both recoverable electrical faults and recoverable software faults by cycling the power on the channel's circuitry.

As noted herein, the I/O controller 400 may implement a channel reset based on fault detection. In some configurations, when the embedded software 560 detects a fault and concludes that a channel reset is possible, the I/O controller 400 may power off a channel and power it back on to attempt to clear a fault automatically. Alternatively, or in addition, status reporting from the I/O module 305 to an operator (e.g., a user of the user device 110), a ladder logic program, or the like can be provided such that fault handling may be manually initiated (e.g., an operator may manually choose to clear a fault). Accordingly, in some configurations, a user, an external logic program, or the like may choose to clear a fault by manually resetting a channel through, e.g., an application programming interface (“API”).

Alternatively, or in addition, the I/O controller 400 may control a power state of an individual channel in order to disable a channel circuit 405 (e.g., temporarily). As one non-limiting example, the I/O controller 400 may disable a channel circuit 405 such that a user may repair a circuit (or a component thereof), debug a hardware issue, or the like. In some configurations, the I/O controller 400 may power off a channel circuit 405 so that the channel circuit 405 minimally interferes with the circuitry being repaired or troubleshot.

Alternatively, or in addition, the I/O controller 400 may control a power state of an individual channel (e.g., a channel circuit 405) based on whether the individual channel is used. For instance, a user, an external logic program, or the like may make a channel circuit 405 “unused” (e.g., not powered) when connecting to the I/O module 305. This may be the case when a factory automation is partially up and running, a new feature is being added, or the like. Alternatively, or in addition, the end user may not need the channel circuit 405 in their industrial system design and would like to save the energy, heat dissipation, or the like by not powering the “unused” channel circuit. In such instances, the I/O controller 400 may power off the channel circuit 405 and the power the channel circuit 405 back on if the configuration of the industrial system 115 changes such that the channel circuit 405 is used.

What has been described above includes examples of the disclosed technology. It is, of course, not possible to describe every conceivable combination of components or methodologies for purposes of describing the disclosed technology, but one of ordinary skill in the art may recognize that many further combinations and permutations of the disclosed technology are possible. Accordingly, the disclosed technology is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed technology. In this regard, it will also be recognized that the disclosed technology includes a system as well as a computer-readable medium having computer-executable instructions for performing the acts and/or events of the various methods of the disclosed technology.

In addition, while a particular feature of the disclosed technology may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. An input/output (“I/O”) module for industrial systems, the I/O module comprising:
a plurality of channel circuits for interfacing with industrial control equipment of an industrial system; and
an electronic processor communicatively coupled to each channel circuit via a dedicated hardware communication channel, the electronic processor configured to control a power state for at least one channel circuit included in the plurality of channel circuits.

2. The I/O module of claim 1, wherein the electronic processor is configured to control the power state of the at least one channel circuit by generating and transmitting a control signal to the at least one channel circuit via a corresponding dedicated hardware communication channel communicatively coupling the electronic processor to the at least one channel circuit.

3. The I/O module of claim 1, wherein the electronic processor is configured to control the power state of the at least one channel circuit by disabling power to the at least one channel circuit, wherein the at least one channel circuit is unused by the industrial system.

4. The I/O module of claim 1, wherein the electronic processor is configured to control the power state of the at least one channel circuit by performing a power reset cycle for the at least one channel circuit to clear a fault associated with the at least one channel circuit.

5. The I/O module of claim 1, wherein the electronic processor is configured to control the power state for the at least one channel circuit in response to detecting a fault associated with the at least one channel circuit.

6. The I/O module of claim 1, wherein the electronic processor is configured to control the power state for the at least one channel circuit in response to receiving a remote request from a user device.

7. The I/O module of claim 1, wherein the electronic processor is configured to control the power state for the at least one channel circuit in response to receiving a request automatically initiated by a ladder logic program associated with the I/O module.

8. A system for providing remote channel reset for I/O modules of industrial systems, the system comprising:
a plurality of channel circuits for interfacing with industrial control equipment of an industrial system; and
an electronic processor communicatively coupled to each channel circuit via a dedicated hardware communication channel, the electronic processor configured to control a power state for at least one channel circuit included in the plurality of channel circuits.

9. The system of claim 8, wherein the electronic processor is configured to control the power state for the at least one channel circuit in response to detecting a fault associated with the at least one channel circuit.

10. The system of claim 8, wherein the electronic processor is configured to control the power state for the at least one channel circuit in response to receiving a remote request from a user device.

11. The system of claim 8, wherein the electronic processor is configured to control the power state for the at least one channel circuit in response to receiving a request automatically initiated by an external logic program.

12. The system of claim 8, wherein the electronic processor is configured to control the power state of the at least one channel circuit by disabling power to the at least one channel circuit, wherein the at least one channel circuit is unused.

13. The system of claim 8, wherein the electronic processor is configured to control the power state of the at least one channel circuit by performing a power reset cycle for the at least one channel circuit to clear a fault associated with the at least one channel circuit.

14. The system of claim 8, wherein the electronic processor is configured to control the power state of the at least one channel circuit by generating and transmitting a control signal to the at least one channel circuit via a corresponding dedicated hardware communication channel communicatively coupling the electronic processor to the at least one channel circuit.

15. A method for providing remote channel reset for I/O modules of industrial systems, the method comprising:
providing a multichannel I/O module for implementation with an industrial system, the multichannel I/O module including a first channel circuit and a second channel circuit, wherein the first channel circuit is controlled independently from the second channel circuit; and
controlling, with an electronic processor communicatively coupled to the first channel circuit and the second channel circuit, a first power state associated with the first channel circuit via transmission of a first control signal using a first dedicated hardware communication channel communicatively coupling the electronic processor to the first channel circuit.

16. The method of claim 15, further comprising:
controlling, with the electronic processor, a second power state of the second channel circuit via transmission of a second control signal using a second dedicated hardware communication channel communicatively coupling the electrical processor to the second channel circuit, wherein the first dedicated hardware communication channel is different from the second dedicated hardware communication channel.

17. The method of claim 15, wherein controlling the first power state includes performing a power reset cycle for the first channel circuit.

18. The method of claim 17, wherein controlling the power reset cycle includes clearing a hardware fault associated with the first channel circuit.

19. The method of claim 17, wherein controlling the power reset cycle includes clearing a software fault associated with the first channel circuit.

20. The method of claim 15, wherein controlling the first power state for the first channel circuit includes controlling the first power state in response to detecting a fault associated with the first channel circuit.
